(19) United States
(12) Patent Application Publication
(10) Pub. No.: US 2026/0003202 A1
(43) Pub. Date: Jan. 1, 2026

(54) META-LENS, OPTICAL SYSTEM, IMAGE PROJECTION DEVICE, LIGHT SOURCE DEVICE, IMAGING DEVICE, OPTICAL SCANNING DEVICE, AND MEDICAL IMAGE PROJECTION DEVICE

(71) Applicant: OPTOWL Co., Ltd., Hanamaki-shi (JP)

(72) Inventors: Hirokazu Narita, Hanamaki-shi (JP); Hayato Yoshida, Hanamaki-shi (JP); Yasuhiro Fujimura, Hanamaki-shi (JP); Kenichi Ishizuka, Hanamaki-shi (JP); Daisuke Sasaki, Hanamaki-shi (JP); Tomohiro Nakajima, Hanamaki-shi (JP)

(21) Appl. No.: 19/243,700

(22) Filed: Jun. 20, 2025

(30) Foreign Application Priority Data
Jun. 27, 2024 (JP) 2024-103569
Oct. 11, 2024 (JP) 2024-179401
Dec. 3, 2024 (JP) 2024-210689

(51) Int. Cl. G02B 27/18; B82Y 20/00; G02B 1/00; G02B 26/12; G02B 27/09; G02B 27/42

(52) U.S. Cl. CPC G02B 27/18; B82Y 20/00; G02B 1/002; G02B 26/124; G02B 27/0955; G02B 27/4227

(57) ABSTRACT

Provided is a meta-lens that reduces influence of 0th order light by guiding 1st order light for obtaining a signal to a position outside a light path of the 0th order light when constructing an optical system using the meta-lens. The meta-lens according to the present invention is a meta-lens that has a light transmission surface on which a plurality of fine structures are consecutively provided and adjusts a refractive index for light on the basis of a density of the fine structures, and includes a light path separator that causes 1st order light and 0th order light of light that has passed through the transmission surface to travel along different light paths, the 1st order light being light that has been influenced by refraction caused by the fine structures, and the 0th order light being light that has not been influenced by refraction caused by the fine structures.

### BACKGROUND OF THE INVENTION

### 1. Field of the Invention

The present invention relates to a meta-lens, and an optical system, an image projection device, a light source device, an imaging device, an optical scanning device, and a medical image projection device using the meta-lens.

### 2. Description of the Related Art

A meta-material having periodic structures finer than a wavelength is an artificial material that does not exist in nature, and a two-dimensional meta-material is called a meta-surface.

Since an interval or a size of fine periodic structures (meta-atoms) that constitute a meta-surface depends on a wavelength, an intelligent reflecting surface, a beam scanning antenna, and the like are being actively developed in fields of a relatively large wavelength region (radio frequency).

On the other hand, in an optical field that uses a visible light region, a required size of meta-atoms is small, specifically, several hundred nm because of a small wavelength, which makes fabrication difficult. Such difficult fabrication creates a barrier.

However, in recent years, techniques such as elaborate engraving of glass or a dielectric material are progressing thanks to application of a semiconductor processing technique, and development of an optical element using such a meta-surface is also in progress in the optical field (see, for example, Japanese Unexamined Patent Application Publication (Translation of PCT Application) No. 2022-502715, Japanese Unexamined Patent Application Publication No. 2024-45435, and ACS Photonics 2024, 11(3), 816-865 Publication Date: Feb. 27, 2024).

Among meta-surfaces using such techniques, a meta-lens is a nanodevice having nanosized fine structures. The meta-lens has a light focusing effect like a lens, and can be markedly reduced in thickness as compared with a conventional refractive lens. There are several kinds of working principles, and it is already known that, basically, an amplitude and a phase of light are controlled when the light passes through or reflected by a meta-lens.

It is known that an actually fabricated meta-lens has some degree of error in fine pattern shape due to the difficult fabrication described above, which makes it impossible to obtain a desired lens effect and slightly generates a light beam that travels straight.

Such a light beam that travels straight is called 0th order light as compared with 1st order light that has obtained a desired lens effect, and the 0th order light moves along an optical path different from an assumed desired optical path, and therefore can cause a signal error or noise.

For example, it is becoming clear that if a meta-lens is applied to a conventional light scanning optical system or the like such as the one described in Japanese Patent No. 2978221, noise or a signal error occurs due to 0th order light.

Although some methods for reducing 0th order light itself have been conceived to solve such a problem, reducing 0th order light, for example, by improving processing accuracy or diffusing 0th order light is not a fundamental solution.

### SUMMARY OF THE INVENTION

The present invention was accomplished to solve the above problem, and an object of the present invention is to use both 1st order light for obtaining a signal and 0th order light by making a light path of the 1st order light and a light path of the 0th order light different in a case where an optical system using a meta-lens is constructed.

The present invention provides a transmission-type meta-lens that has a light transmission surface on which a plurality of fine structures are consecutively provided and adjusts a refractive index for light on the basis of a density of the fine structures, the transmission-type meta-lens including a light path separator that causes 1st order light and 0th order light of light that has passed through the transmission surface to travel along different light paths, the 1st order light being light that has been influenced by refraction caused by the fine structures, and the 0th order light being light that has not been influenced by refraction caused by the fine structures.

According to the present invention, influence of 0th order light can be reduced by guiding the 0th order light to an outside of a light path of 1st order light for obtaining a signal in a case where an optical system using a meta-lens is constructed.

### BRIEF DESCRIPTION OF THE DRAWINGS

FIG. 1 illustrates an outline configuration of a meta-lens according to a first embodiment of the present invention.

FIG. 2 schematically illustrates an example of fine structures on a surface of the meta-lens illustrated in FIG. 1.

FIG. 3 schematically illustrates refraction by a convex lens.

FIG. 4 schematically illustrates a change in refractive index caused by the fine structures illustrated in FIG. 2.

FIG. 5 illustrates a structure of a transmission surface of the meta-lens.

FIG. 6 is a diagram for explaining an example of a method for generating a meta-surface.

FIG. 7 is a chart for explaining an example of a method for generating a meta-lens.

FIG. 8 illustrates a comparative example of a conventional optical scanning device.

FIG. 9 is a diagram for explaining action caused by 0th order light generated by using the meta-lens.

FIG. 10 illustrates an example of a function of the meta-lens according to the present invention for preventing the action illustrated in FIG. 9.

FIG. 11 is a diagram illustrating an example of a configuration of the meta-lens according to the present invention.

FIG. 12 illustrates a comparative example in which a meta-lens different from the meta-lens according to the present invention is used.

FIG. 13 illustrates an example of a specific condition of a configuration of the meta-lens according to the present invention.

FIG. 14 is a diagram illustrating an example of a configuration of an optical device using the meta-lens according to the present invention.

FIG. 15 is a diagram illustrating an example of a configuration of an image projection device using the meta-lens according to the present invention.

FIG. 16 is a diagram illustrating an example of a configuration of an imaging device using the meta-lens according to the present invention.

FIG. 17 is a diagram illustrating an example of a configuration of a laser beam machine using the meta-lens according to the present invention.

FIG. 18 illustrates another example of the meta-lens according to the present invention.

FIG. 19 illustrates another example of the meta-lens illustrated in FIG. 18.

FIG. 20 is a diagram illustrating an example of a configuration of a preventive medical care system according to the present invention.

FIG. 21 is a diagram illustrating an example of a configuration of an optical system of an image projection device illustrated in FIG. 20.

FIG. 22 is a schematic view illustrating an example of a configuration for photographing a retina and a blood vessel by a light flux incident from the image projection device.

FIG. 23 is a diagram illustrating an example of a configuration of projection light in the image projection device.

FIG. 24 illustrates an outline configuration of the projection light and a pupil position viewed from a direction different from FIG. 23.

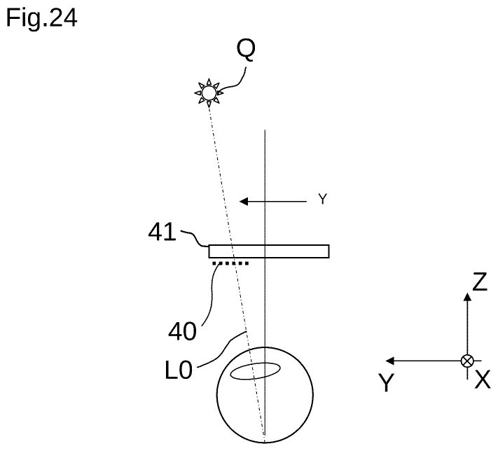

FIG. 25 schematically illustrates a reason why a pupil position is specified by a projection position of 0th order light.

FIG. 26 illustrates an example of a method for controlling transmittance of the meta-lens illustrated in FIG. 21.

FIG. 27 is a diagram illustrating an example of a configuration of a bisected photodetector including a meta-lens that separates return light into light beams of two wavelengths by chromatic aberration.

FIG. 28 is a diagram illustrating an example of a configuration of a display-transmission-type imaging device using the meta-lens according to the present invention.

FIG. 29 is a diagram illustrating an example of a configuration in which refraction of 1st order light in the meta-lens according to the present invention is diffraction/reflection type.

### DESCRIPTION OF THE PREFERRED EMBODIMENTS

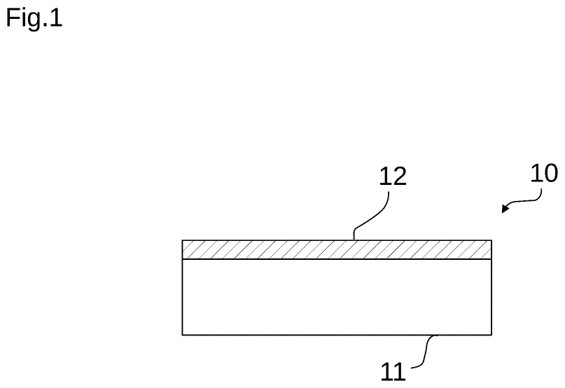

FIG. 1 illustrates an example of a configuration of a meta-lens having a meta-surface as a first embodiment of the present invention.

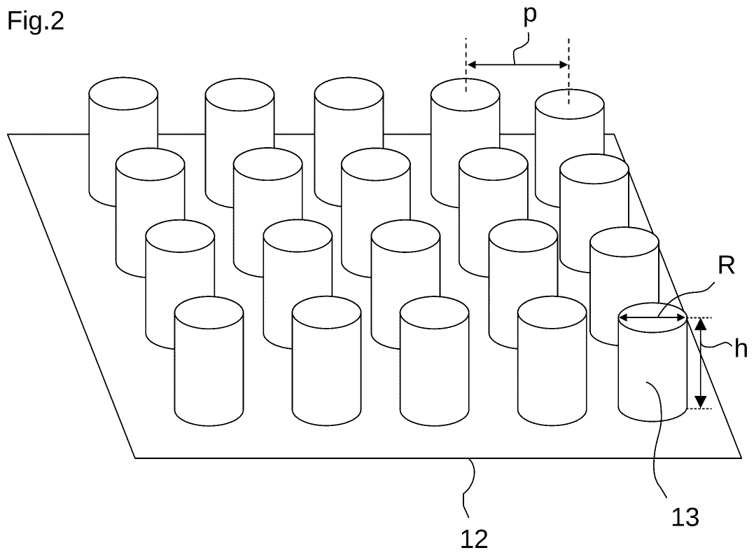

In FIG. 1, a meta-lens 10 is illustrated as an example of an optical element including a substrate portion 11, which is plate-shaped quartz glass, and a plurality of pillars 13 having a columnar shape, which are fine structures provided on a light transmission surface 12 of the substrate portion 11. Although the pillars 13 are illustrated as columnar fine structures having a diameter R in FIG. 2, the pillars 13 are not limited to such a configuration, and the pillars 13 may be, for example, polygonal columns having a polygonal upper surface such as a triangular, quadrangular, or hexagonal upper surface, may have a shape combining rectangles, or may have a shape obtained by elongating any of these shapes in one direction.

The transmission surface 12 functions as a meta-surface in a case where an interval between the pillars 13 is a sub-wavelength interval with respect to transmitted light.

Although the transmitted light may have any wavelength, light of λ=532 nm is, for example, handled as an example of light in a visible light region in the present embodiment.

In a case where the pillars 13 has a diameter R and an interval between adjacent pillars 13 is a pitch p, functionality of the transmission surface 12 as a meta-surface varies depending on a filling rate of the pillars 13.

This is because the pillars 13 act as meta-atoms that inhibit progress of an incident light wave in a case where the pitch p is a sub-wavelength interval.

Furthermore, it is known that a refractive index different from a refractive index of a material for the pillars 13 can be given to the whole transmission surface 12 by changing the filling rate, that is, a density of the pillars 13.

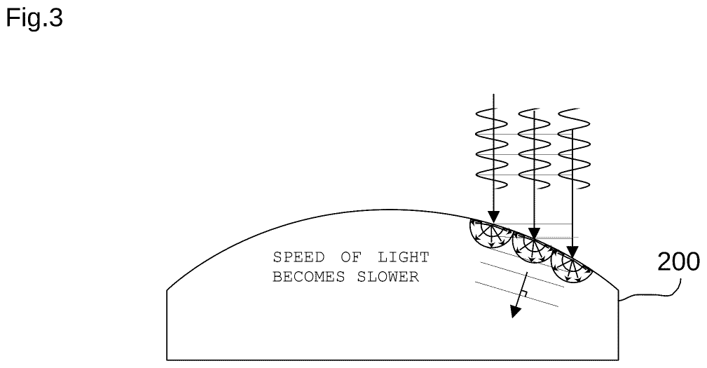

To explain this, FIG. 3 illustrates, as a simple example, progress of light waves in a convex lens together with phase wavefronts.

In FIG. 3, portions where phases of parallel line beams that are adjacent to each other match are schematically indicated by thin lines as phase wavefronts. Needless to say, a direction normal to the phase wavefronts is a light travelling direction.

When light enters a convex lens 200 having a refractive index n, a speed of the light becomes slower according to the refractive index, and therefore phase wavefronts are inclined toward the convex portion of the convex lens 200 with respect to parallel light beams. Since a direction in which the series of phase wavefronts progress is a light travelling direction, the light travelling direction is a tangential direction of the series of phase wavefronts and is bent toward an optical axis of the convex lens 200, as illustrated in FIG. 3.

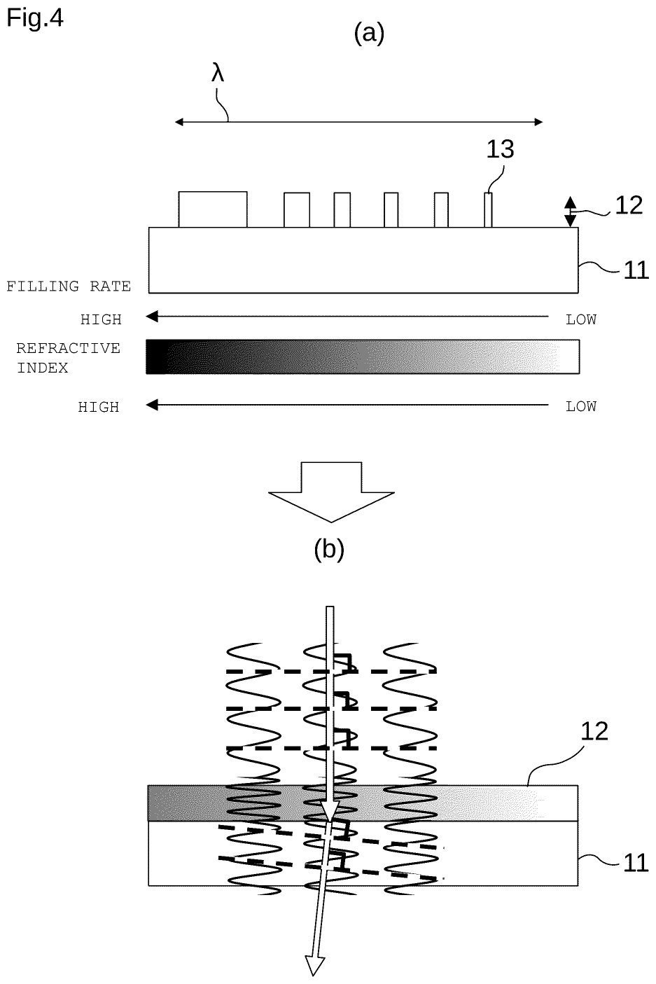

FIGS. 4A and 4B schematically illustrate an effect of the pillars 13 on the transmission surface 12, which is a meta-surface. As illustrated in FIG. 4A, in a case where the pillars 13 smaller than a wavelength A stand on the transmission surface 12, light of the wavelength A does not recognize the pillars 13 as individual columns, but recognize the pillars 13 as a difference in refractive index of the transmission surface 12 depending on a difference in filling rate.

That is, an apparent refractive index n2 of the transmission surface 12, which is a meta-surface, changes depending on the diameter or height of the pillars 13 or the interval (pitch) of the standing pillars 13. A difference in the refractive index n2 is roughly indicated by color gradations in FIG. 4A.

Accordingly, as illustrated in FIG. 4B, when parallel light beams perpendicularly enter the transmission surface 12, progress of a phase wavefront of a light beam entering the transmission surface 12 is slower in a portion where the refractive index is larger, as illustrated in FIG. 4B. As described above, a difference in refractive index of the transmission surface 12 corresponds to a difference in filling rate of the pillars 13. In other words, for transmitted light, change of the filling rate of the pillars 13 on the transmission surface 12 is equivalent to change of a light path length of the portion.

As with the refractive index of the convex lens 200 illustrated in FIG. 3, a refraction effect similar to that of the convex lens 200 can be given by giving delay based on the refractive index of the transmission surface 12 by a same amount as phase wavefronts delayed due to a difference in light path length resulting from a lens thickness.

As described above, in a case where the pillars 13 have a sub-wavelength order with respect to the wavelength A of the light and the refractive index of the transmission surface 12 is given a gradient by the filling rate as illustrated in FIG. 4B, progress of wavefronts is delayed depending on the filling rate of the pillars 13, and therefore phase wavefronts are inclined to the left in FIG. 4B, as illustrated in FIG. 4B.

In a case where the plurality of pillars 13 of a sub-wavelength order are regularly arranged, this phenomenon plays a role similar to atoms for a light wave traveling in a molecule crystal lattice, and phase wavefronts are distorted as if refraction has occurred.

Conversely, if such distortion of phase wavefronts can be artificially created by regularity of the pillars 13, the transmission surface 12 has an optical function equivalent to a lens surface of the refractive index n2.

That is, if a distribution of diameters of the pillars 13 can be created so that phase wavefronts of transmitted light passing through the transmission surface 12 match phase wavefronts of light transmitting through a convex lens of the refractive index n2, the light passing through the transmission surface 12 is similar to light transmitting through the convex lens of the refractive index n2.

This is a brief description of a principle of an optical functional surface called a meta-surface, and fine structures such as the pillars 13 on such an optical functional surface are sometimes called meta-atoms by making an analogy to atoms.

As described above, by appropriately changing the filling rate of the pillars 13 provided on the transmission surface 12, phase wavefronts of light at each position of the transmission surface 12 can be controlled, and thus the meta-lens 10 can be given functionality like various optical lenses while keeping a flat plate shape from a macroscopic standpoint.

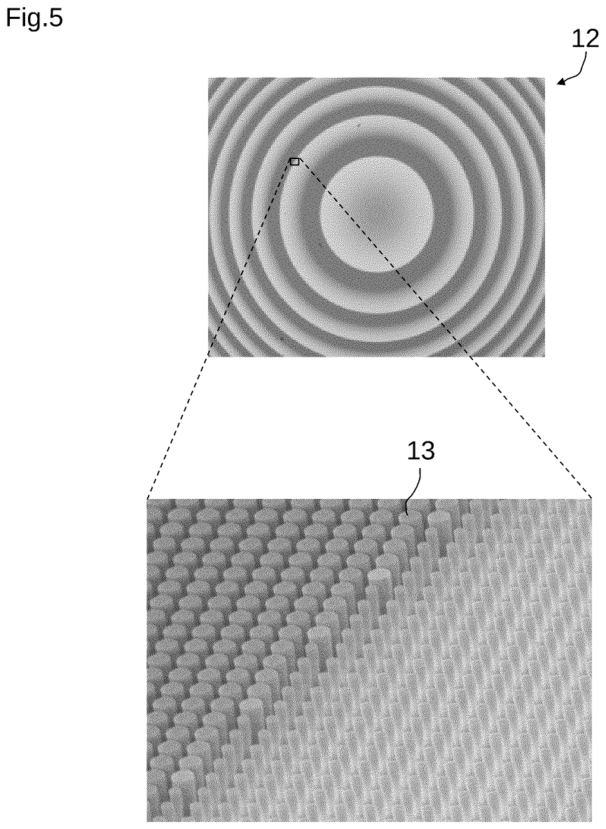

FIG. 5 illustrates an example of the transmission surface 12 of the meta-lens 10 and an enlarged view enlarged to such a degree that the pillars 13 are visible.

The pillars 13 provided on the transmission surface 12 of the present embodiment illustrated in FIG. 5 are sufficiently small as compared with a wavelength of light to be transmitted. As is clear from FIG. 5, although the diameters of the pillars 13 are controlled to change the filling rate in the present embodiment, the pitch p may be properly set, for example, on the basis of a long side/short side or a length of a diagonal line in a case where the pillars 13 are quadrangular prisms and may be properly set, for example, on the basis of a length of one side in a case where the pillars 13 are triangular prisms. In either case, a distance between the pillars 13 that is most typical geometrically when the pillars 13 are viewed perpendicularly may be handled as the pitch p in a horizontal direction/vertical direction.

Note that although detailed design conditions and a manufacturing method are described in related arts and are therefore omitted, simply taking a correspondence between values of phase wavefronts of incident light and filling rates, for example, by using light beam simulation software, the obtained value is a discretized value of a lens surface, and a range which a density can take is wide.

In general, sizes of the diameters of the pillars 13 provided on the meta-lens 10 are finite, and in a case where the filling rate is controlled by the diameters of the columnar pillars 13, upper surfaces of the pillars 13 are circular, and therefore a filling rate of a circle with respect to a rectangle is approximately 78% at maximum.

The diameters of the pillars 13 need be set equal to or less than a wavelength at maximum. Therefore, in a case where the filling rate is decided only by a coefficient proportional to a value of a phase wavefront, characteristics of the meta-lens 10 as a meta-surface cannot be sufficiently exhibited, and therefore the filling rate of the pillars 13 needs to be included in a certain range.

In view of this, for example, a method of calculating a value of a phase wavefront and then calculating, as a filling rate, a remainder obtained when each value is divided by 2π is taken as a typical method for making a phase wavefront similar to that of a refractive lens by a filling rate.

Since values of phase wavefronts calculated by such a calculation method indicate that a filling rate fluctuates on a cycle of 2π, concentric bright and dark lines appear in accordance with the cycle of phases, as illustrated in FIG. 5. Accordingly, in a case where the transmission surface 12 is formed by using a method different from such a method, the meta-lens 10 that does not exhibit light intensities such as the ones illustrated in FIG. 5 may be obtained.

An example of a method for manufacturing the transmission surface 12 is described.

Conventionally, a method such as electron beam lithography (EBL) is used to form a plurality of fine structures such as the ones illustrated in FIG. 5. Such a method is widely used to manufacture a meta-surface since a resolution is less than 10 nm. However, this method requires time and cost, and therefore a more efficient manufacturing method is required.

As such a large-area and high-efficiency manufacturing method, for example, a nanoimprint transfer method using a mold 81 formed by lithography is known.

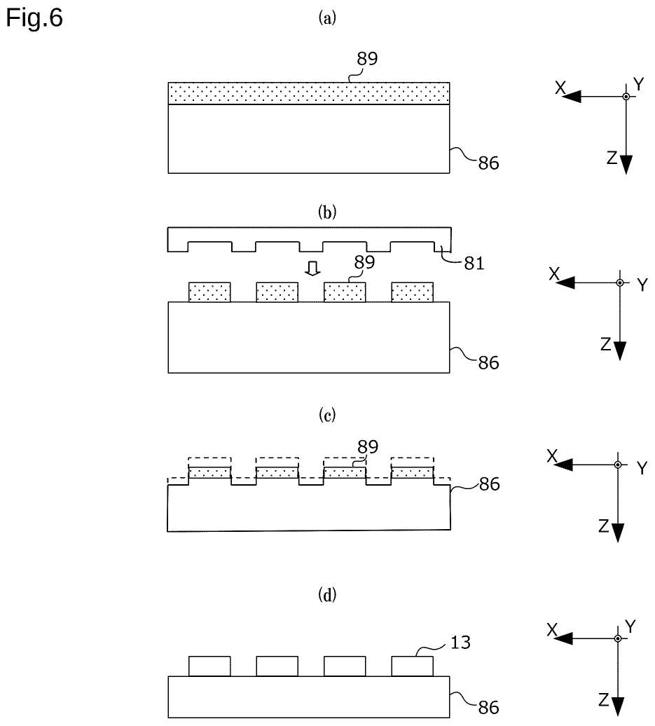

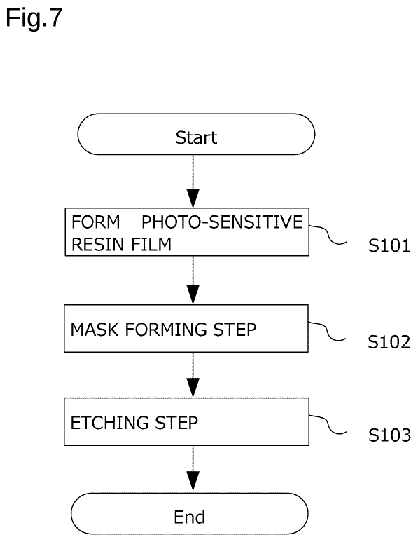

An example of a method for manufacturing an optical element including the meta-lens 10 is described with reference to FIGS. 6 and 7.

As illustrated in FIG. 6A, first, a resist layer 89 made of a photo-sensitive resin is formed on a quartz substrate 86, which is a material constituting the substrate portion 11 of the meta-lens 10 (step S101).

A mold 81 having a pattern of cylindrical or polygonal prism shaped gaps formed in accordance with processing data in which recessed and raised portions are reverse to the pillars 13 to be finally obtained are pressed against the resist layer 89 formed on the quartz substrate 86, and thereby layers having the same shape as the pillars 13 are formed (step S102).

Step S102 is a mask forming step of forming a mask pattern by using the resist layer 89. In the mask forming step, a pattern imitating the shapes of the pillars 13 to be manufactured is formed on a surface of the quartz substrate 86 by using the resist layer 89.

In this mask forming step, a height from a lower end to an upper end of a pillar shape formed by the resist layer 89, in other words, a thickness of the resist layer 89 is decided as appropriate from an etching speed of the quartz substrate 86, which will be described later.

Although the mask is formed by nanoimprint using the mold 81 in the present embodiment, the mask may be formed by photolithography or the like.

Next, dry etching such as ECR plasma etching or RIE etching is performed by using etching gas obtained by mixing oxygen gas for etching a photo-sensitive resin and fluorocarbon gas for etching synthetic quartz glass (step S103).

In the etching step in step S104, the resist layer 89 and the quartz substrate 86 are etched in a state where the shapes of the resist layer 89 have been transferred onto the quartz substrate 86, as illustrated in FIG. 6C.

When the etching step progresses until the resist layer 89 is removed, the shapes of the resist layer 89 are transferred onto the quartz substrate 86, and thereby the pillars 13 are formed, as illustrated in FIG. 6D.

A similar manufacturing method can be applied, for example, to a multi-layer substrate in which a different material is laminated on the quartz substrate 86.

In a case where a material that is not etched or is hardly etched by etching gas is selected, the thickness of the resist layer 89 can be controlled freely to some extent, and the pillars 13 are formed in a similar manner.

Similarly, an etching speed may be controlled in accordance with a layer thickness by a method such as changing a mixture ratio of etching gas.

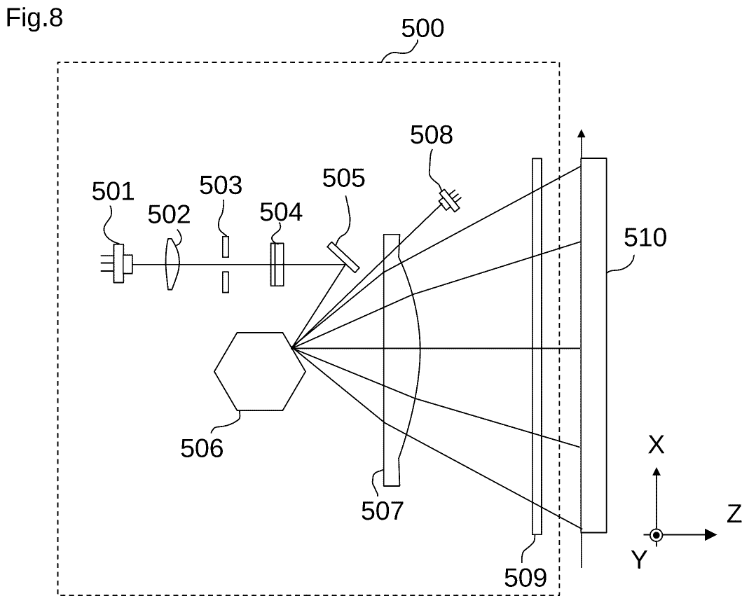

First, a configuration of a conventional optical scanning device 500 illustrated in FIG. 8 is described before description of an optical system using the meta-lens 10. The optical scanning device 500 includes a light source optical system including a laser light source 501, a coupling lens 502, an aperture 503, a cylinder lens 504, and a turning back mirror 505. The optical scanning device 500 further includes a light deflector 506, which is a polygon mirror for reflecting light by a mirror on a side surface by rotating and scanning the reflected light, and a fθ lens 507, and a surface of a photoreceptor 510 to be irradiated is irradiated with light in a main scanning direction and a sub scanning direction.

Part of the light that has passed through the fθ lens 507 is input to a detection sensor 508, which is a detector, and is used for synchronization of rotation of the light deflector 506 and is incident on the photoreceptor 510, which is an imaging surface, after being corrected by a plane tilt correction lens 509.

The light deflector 506 is a rotating mirror having a hexagonal prism shape having a mirror on a side surface, and scans incident light in an X direction, which is a main scanning direction, with time by rotating about a Z axis.

The light forms a latent image on the photoreceptor 510, and an image formed on a surface of the photoreceptor 510 is output as a final actual image in an image forming device, but detailed description of a related art is omitted in the present embodiment.

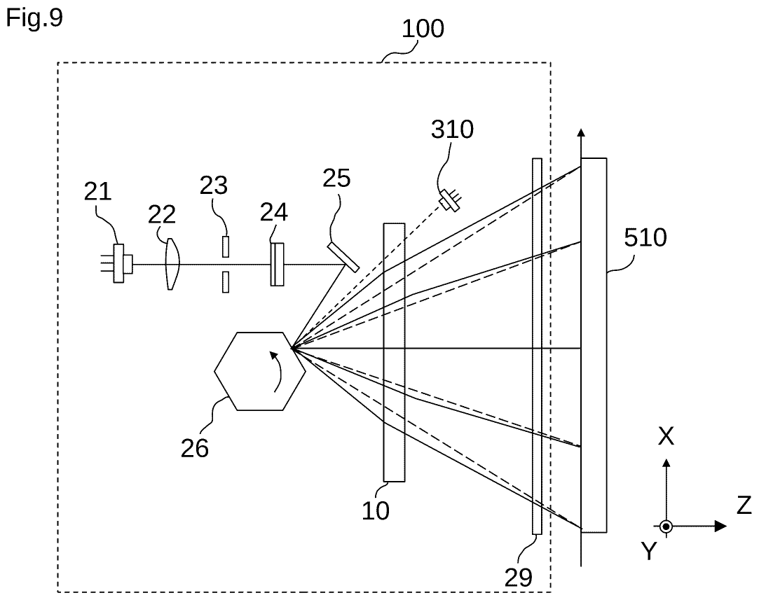

In the present embodiment, the fθ lens 507 of the optical scanning device 500 is replaced with the meta-lens 10, as illustrated in FIG. 9.

An optical scanning device 100 according to the present embodiment includes a light source optical system including a laser light source 21, a coupling lens 22, an aperture 23, a cylinder lens 24, and a turning back mirror 25, as with the optical scanning device 500.

The optical scanning device 100 is also similar to the optical scanning device 500 in that light reflected by the light deflector 26, which is a polygon mirror, is incident on the photoreceptor 510 after passing through the meta-lens 10.

In the present invention, the optical scanning device 100 includes an output detection sensor 310, which is a detector, and a plane tilt correction lens 29, and the output detection sensor 310 is used to achieve synchronization with the light deflector 26 by receiving part of 0th order light L0 of the meta-lens 10, as described later.

Also in the present embodiment, the light deflector 26 is a polygon mirror having a hexagonal prism shape whose side surfaces are mirror surfaces. As illustrated in FIG. 9, the light deflector 26 rotates about a rotation axis extending in a direction perpendicular to the paper surface and thereby scans light incident from the turning back mirror 25 in a main scanning direction.

The laser light moves so as to be scanned on the photoreceptor 510, and the laser light moves so that a rotation angle θ of the light deflector 26 is proportional to an image height in the main scanning direction.

The meta-lens 10 according to the present embodiment is a meta-lens in which the filling rate of the pillars 13 on the transmission surface 12 is decided so that refraction of transmitted light based on a refractive index illustrated in FIG. 4 takes a trajectory similar to the fθ lens 507.

In a case where a conventional optical element is merely replaced by the meta-lens 10 as described above, light that travels straight due to influence of an error in shape of the pillars 13 having a fine shape provided on the surface of the transmission surface 12 is slightly generated. This phenomenon occurs, for example, because “missing” occurs due to a formation defect or the like of the pillars 13 or because the pillars 13 do not exhibit an effect as meta-atoms depending on a relationship between an incident angle and an incident position on the transmission surface 12.

This light is light called 0th order light, and the 0th order light L0 is incident at an image height position that is not proportional to the rotation angle θ of the photoreceptor 510 as indicated by the broken lines in FIG. 9 if no measure is taken, and it is concerned that the 0th order light L0 causes noise or an error.

As a matter of course, the 0th order light L0 does not occur in a case where the fθ lens 507 is used, and no measure against such light is taken in the optical scanning device 500.

One method is to give refractive power in a diffractive optical element such as a DOE. In this case, light that is not diffracted is called 0th order light, and diffracted light corresponding to 1st order light is separated into two or more light beams, and therefore some methods have been proposed as the measure.

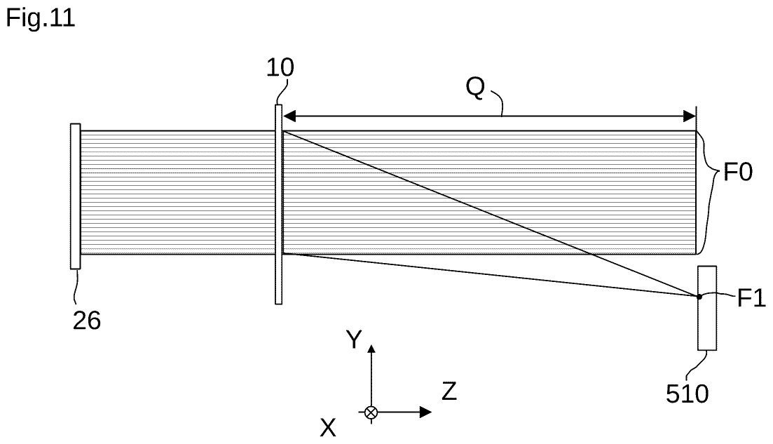

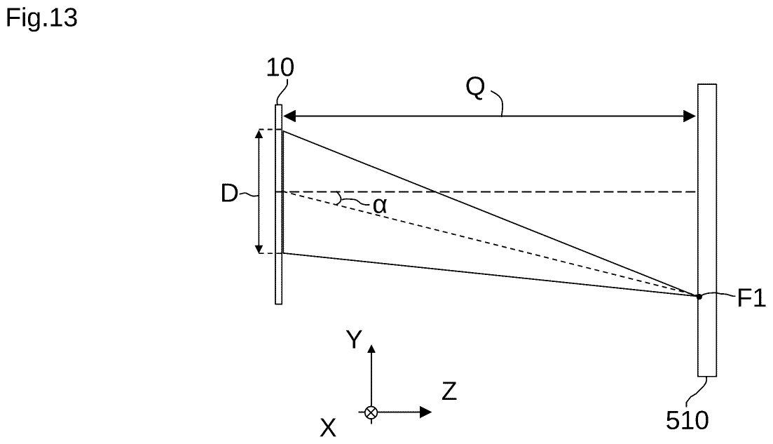

However, although the 1st order light appears symmetrically on both sides with respect to diffractive 0th order light, a focal point of 1st order light L1 can be deviated with respect to 0th order light L0 in the meta-lens 10 according to the present invention, as described later with reference to FIGS. 11, 13, and other drawings. Therefore, a method different from the measure against the diffractive 0th order light is needed.

In the present embodiment, a light path of the 0th order light L0 and a light path of the 1st order light L1 on an optically downstream side relative to the meta-lens 10 are made different by controlling the filling rate of the pillars 13 on the transmission surface 12, as illustrated in FIG. 9, and thereby the 0th order light L0 and the 1st order light L1 are separated so that the 0th order light L0 is not mixed with the light path of the 1st order light L1.

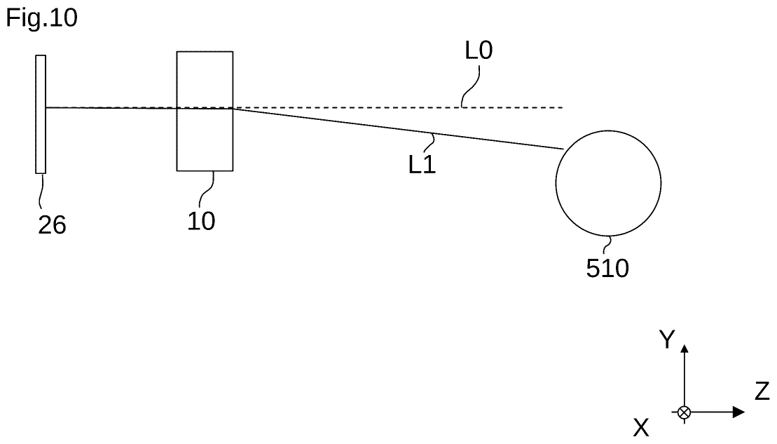

That is, the meta-lens 10 according to the present embodiment has not only the same optical function as a fθ lens due to a difference in filling rate of the pillars 13 on the transmission surface 12 as described above, but also a function of bending the 1st order light L1 in a Y direction, which is a sub-scanning direction, by giving refractive power also in the Y direction, as illustrated in FIG. 10.

FIG. 10 is a conceptual diagram of such a configuration.

In FIG. 10, an incident light flux that passes through the transmission surface 12 is separated into the 0th order light L0 that has not been influenced by refraction of the pillars 13 on the transmission surface 12 as indicated by the broken lines and the 1st order light L1 refracted by the pillars 13 on the transmission surface 12 as indicated by the solid lines.

Since the 0th order light L0 is light that has not been influenced by refraction or has not been sufficiently influenced by refraction in principle, the 0th order light L0 travels straight through the meta-lens 10 while keeping an almost same diameter as the incident light flux.

On the other hand, the 1st order light L1 is light that is influenced by refraction on the transmission surface 12. Accordingly, the 1st order light L1 can be, for example, focused at a desired position by controlling the filling rate so that power is also given in the Y direction of the meta-lens 10.

FIG. 11 schematically illustrates such a concept, and illustrates a state where refractive power of the meta-lens 10 in the Y direction is controlled so that a focal spot F1 of the 1st order light L1 is outside an irradiation range F0 of the 0th order light L0 on an imaging surface (here, the photoreceptor 510) of an optical system using the meta-lens 10.

According to this configuration, in a case where the 1st order light L1 is used, the photoreceptor 510 can be located outside the irradiation range F0 of the 0th order light L0, as illustrated in FIG. 11, and therefore the 0th order light L0 does not cause noise or an error on the photoreceptor 510.

Furthermore, a light path on an optically downstream side or a position of the photoreceptor 510 serving as an imaging surface is also changed in accordance with the focal spot F1 of the 1st order light L1 of the meta-lens 10.

Note that the output detection sensor 310 illustrated in FIG. 9 is provided at a position where the 0th order light L0 is incident since achieving synchronization by using the 0th order light L0 is more efficient also from a perspective of a rate of use of the 1st order light L1.

Note that although only space is illustrated in a stage following the meta-lens 10 in FIG. 11, FIG. 11 is merely schematic illustration of a light path length, and, for example, an optical system such as a reflecting mirror may be provided to make light paths on a downstream side relative to the meta-lens 10 different so that the 1st order light L1 and the 0th order light L0 are not combined on the way.

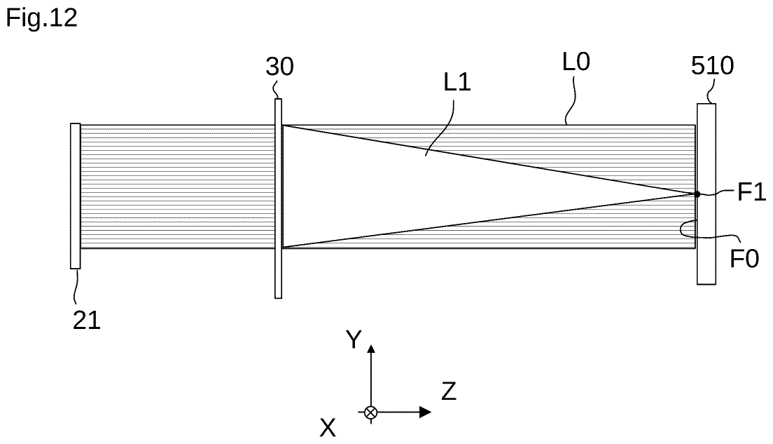

On the other hand, as illustrated as a comparative example in FIG. 12, in a case where a meta-lens 30 that merely functions as a fθ lens is provided, the focal spot F1 of the 1st order light L1 is present within the irradiation range of the 0th order light L0, and it is therefore difficult to separate the two types of light, specifically, the 0th order light L0 and the 1st order light L1, and in a case where light is used at the focal spot F1 of the 1st order light L1, influence such as noise or an error caused by stray light cannot be reduced.

As described above, according to the present invention, the meta-lens 10 has a refractive index gradient on the transmission surface 12 so that the 1st order light L1 that has been influenced by refraction of the pillars 13 and the 0th order light L0 that has not been influenced by refraction of the pillars 13 among light beams that have passed through the transmission surface 12 travel along different light paths.

Such refractive index gradient makes it possible to extract only the 1st order light L1 that has been influenced by the pillars 13 separately from the 0th order light L0 that travels straight without being diffracted so that the photoreceptor 510 serving as an imaging surface is irradiated only with the 1st order light L1, as illustrated in FIG. 10. That is, the transmission surface 12 where the refractive index gradient is reproduced and implemented by the filling rate of the pillars 13 functions as a light path separator according to the present embodiment.

Furthermore, the transmission surface 12 has a function of focusing the 1st order light L1 at a position outside the irradiation range F0 of the 0th order light L0 on a surface of the photoreceptor 510, which is an imaging surface position of the meta-lens 10, as illustrated in FIG. 11.

This is equivalent to saying that an inclination angle x of an optical axis of the 1st order light L1 with respect to an optical axis center of the transmission surface 12 satisfies the following conditional expression 1:

$$tan α > \frac{D}{2 Q} \qquad ( 1 )$$

where D is an effective incident diameter of the meta-lens 10 and Q is an optical length to the imaging surface, as illustrated in FIG. 13.

In the conditional expression 1, the optical axis center of the transmission surface 12 matches an optical axis center of the 0th order light L0. Accordingly, a similar expression can be established even in a case where θ is replaced accordingly and an angle of the optical axis of the L1 with respect to the optical axis of the 0th order light L0 is regarded as α.

In a case where α is defined within the range indicated by the conditional expression 1, the focal spot F1 of the 1st order light L1 of the meta-lens 10 is located outside the range of the incident light flux. According to this configuration, the 0th order light L0 that has not been influenced by refractive power even when passing through the transmission surface 12 of the meta-lens 10 and the 1st order light L1 that has been influenced by refractive power when passing through the transmission surface 12 can be separated, and therefore adverse influence of the 0th order light L0 can be reduced by guiding the 0th order light L0 to a position outside the 1st order light L1 for obtaining a signal when an optical system using the meta-lens 10 is constructed.

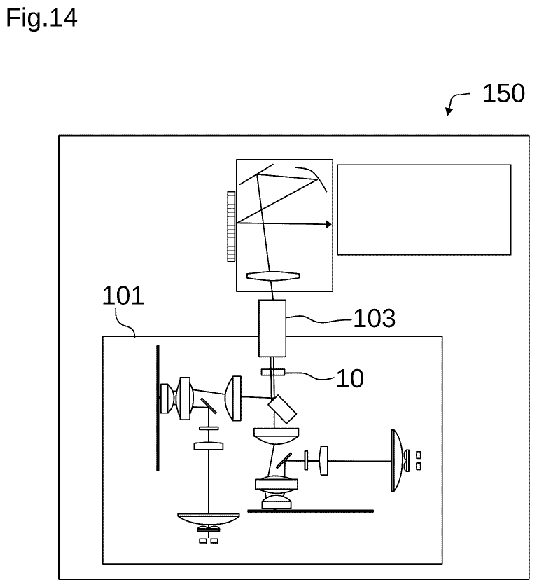

The meta-lens 10 can be applied to various optical devices. For example, the meta-lens 10 can be used as a part of an optical system 101 of an optical device 150 such as the one illustrated in FIG. 14.

The optical system 101 is, for example, an example of an optical system used in a light source device that emits uniform light by using a plurality of laser light sources and using a light tunnel 103.

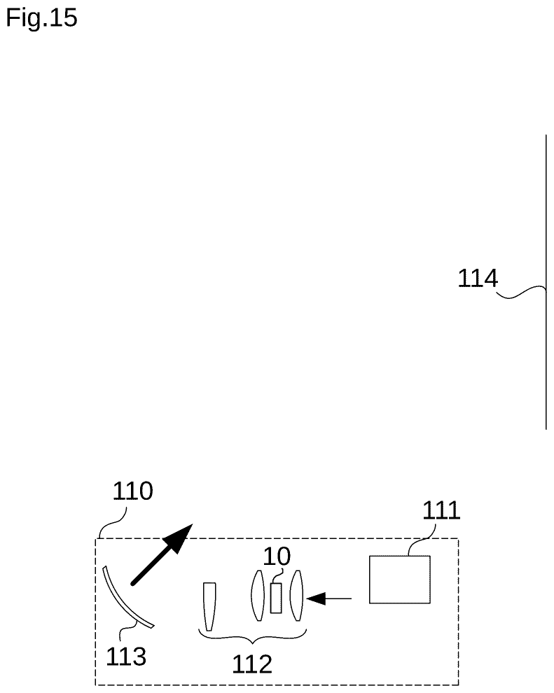

Alternatively, an image projection device 110 illustrated in FIG. 15 is illustrated as an example of an image projection device that includes a light source 111, a projection optical system 112 including the meta-lens 10, and a reflecting mirror 113 and projects an image onto a screen 114, which is a projection surface.

Use of the image projection device 110 makes it possible to reduce influence of stray light or the like while reducing a lens thickness by using the meta-lens 10 in an optical system. It is therefore possible to realize a space-saving and high-performance device.

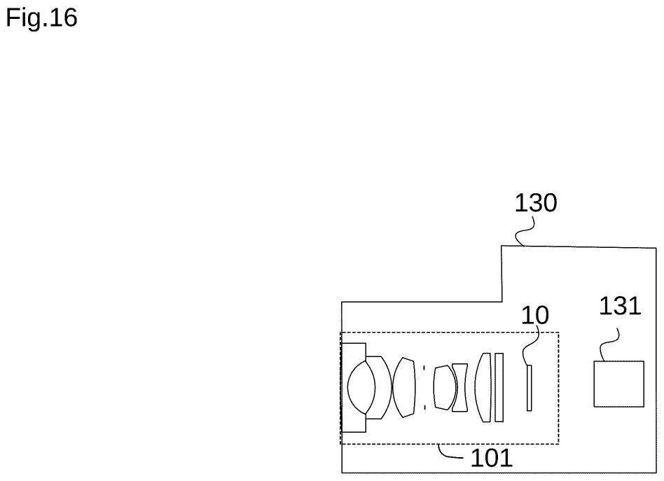

The meta-lens 10 may be used in an imaging device 130 illustrated in FIG. 16 as another example of the optical device 150.

According to this configuration, for example, the 1st order light L1 is used as incident light incident on an imaging element 131.

As described above, the meta-lens 10 can be used as an optical element that constitutes the existing optical system 101.

As another embodiment, an example of a laser light emitting device 300 is described.

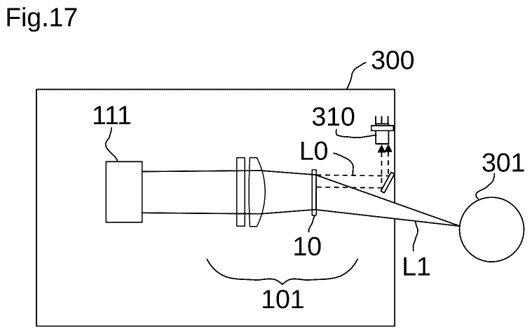

As illustrated in FIG. 17, the laser light emitting device 300 is a laser beam machine that includes a light source 111 and an optical system 101 using the meta-lens 10, and a workpiece 301 to be processed by laser light emitted from the light source 111 is placed at a position corresponding to an imaging surface of the optical system 101.

In such a laser light emitting device 300, a configuration for extracting only part of light by using a beam splitter to check safety of output or the like is conventionally known.

However, laser light output from the laser light emitting device 300 has very high output since the workpiece 301 is irradiated with sufficient energy, and therefore, for example, a thin film that constitutes the beam splitter is sometimes damaged by absorption.

In this respect, the meta-lens 10 obtains an effect as a lens due to minute structures formed on the surface of the transmission surface 12 by using a single material, and therefore it is known that an attenuation rate is very low, for example, in a case where the meta-lens 10 is formed from quartz glass, for example, by the method illustrated in FIG. 6.

Furthermore, it is known that output of the 0th order light L0 is small relative to the 1st order light L1 since the 0th order light L0 occurs due to a defect or the like of the structures on the surface. In addition, since the 0th order light L0 is generated by a total sum of individual light fluxes generated by a defect of a surface shape or the like, an output ratio between the 1st order light and the 0th order light is not markedly changed unless the surface shape is statistically changed.

In view of this, in the present embodiment, the light path of the 0th order light L0 and the light path of the 1st order light L1 are made different by using the meta-lens 10 described above, and the output detection sensor 310, which is a detector for detecting output of the 0th order light L0, is provided on a downstream side of the light path of the 0th order light L0.

According to this configuration, the detector for receiving at least part of the 0th order light L0 and detecting the output of the 0th order light L0 is provided on the light path of the 0th order light L0 on a downstream side relative to the light path separator, and therefore output of the 1st order light L1 can be indirectly detected based on measurement of the output of the 0th order light L0. Therefore, the meta-lens 10 can be used as a high-performance beam splitter.

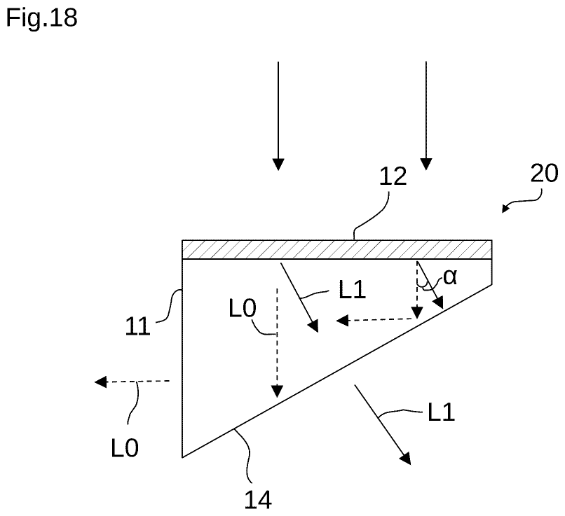

Alternatively, the shape of the meta-lens 10 may be changed to obtain a meta-lens 20 that has an inclined surface 14 that is opposed to the transmission surface 12 and is inclined with respect to the transmission surface 12, as illustrated in FIG. 18.

In this case, the 0th order light L0 and the 1st order light L1 that are separated on the transmission surface 12 are incident on the inclined surface 14 at different angles, and it is therefore possible to achieve a configuration in which the 1st order light L1 passes through the inclined surface 14 and the 0th order light L0 is reflected by the inclined surface 14 by properly setting a reflection condition of the inclined surface 14 and an angle α between the optical axis center of the 0th order light L0 and the optical axis center of the 1st order light L1.

According to such a meta-lens 20, the light path of the 1st order light L1 and the light path of the 0th order light L0 can be clearly separated.

In such a configuration, not only the transmission surface 12, but also the inclined surface 14 function as a light path separator.

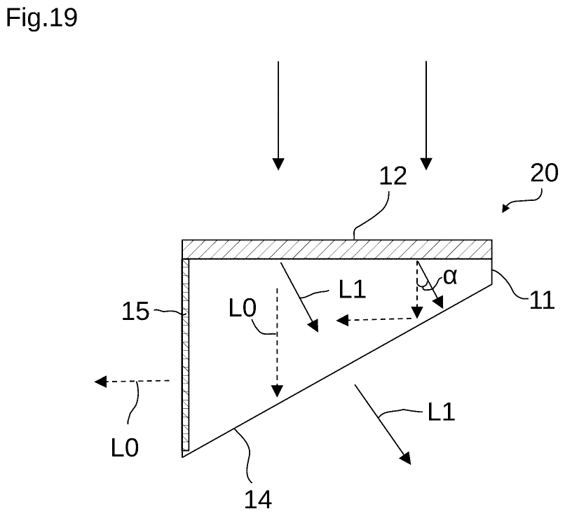

Alternatively, the meta lens 20 may be provided with a diffusion surface 15 for diffusing the 0th order light L0, as illustrated in FIG. 19. In this case, by providing the diffusion surface 15 so that only the 0th order light L0 passes therethrough, an output ratio of the 0th order light L0 with respect to the 1st order light L1 is made smaller, and therefore adverse influence of stray light or the like caused by the 0th order light can be further reduced.

Instead of these configurations, the transmission surface 12 may be given not only refractive power, but also a diffusing function by controlling the filling rate of the pillars 13.

According to this configuration, an output ratio between the 0th order light L0 and the 1st order light L1 can be controlled.

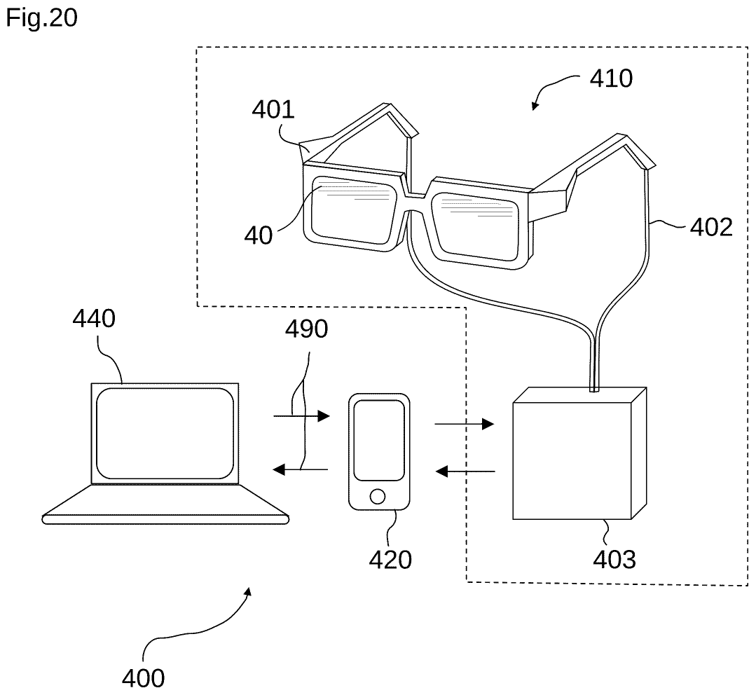

FIG. 20 illustrates an eyeglasses-type or goggles-type image projection device 410 as another embodiment using a meta-lens 40.

The image projection device 410 is a wearable image projection unit that can display a desired image for a user by projecting light before user's eyes.

The image projection device 410 includes an eyeglasses-type body 401 and a controller 403 that is connected to the body 401 by an optical fiber 402 and is integral with a mobile power supply.

The image projection device 410 constitutes a preventive medical care system 400 that examines the ocular fundus of a user wearing the image projection device 410 and transmits examination data from a mobile terminal 420 to a remote diagnosis terminal 440 over a network 490 in the example of FIG. 20.

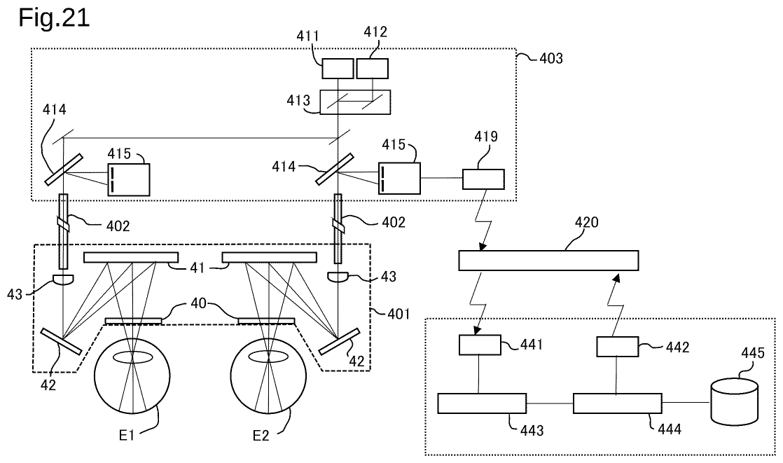

FIG. 21 illustrates an example of a configuration of the image projection device 410.

As illustrated in FIG. 21, the image projection device 410 includes eyepieces 41, meta-lenses 40, deflectors 42, and light collecting lenses 43 that are provided in the eyeglasses-type body 401, and includes the controller 403 that is connected to the body 401 by the optical fiber 402 and is integral with the mobile power supply.

The meta-lenses 40 are located in front of the eyes of the user, and when the user looks at the eyepieces 41 side through the meta-lenses 40 located in front of the eyes, light beams passing through the meta-lenses 40 and the eyepieces 41 make the user see a virtual image. FIG. 21 schematically illustrates a left eye E1 and a right eye E2 of the user.

A half or more of the light that has passed through the meta-lenses 40 makes the user see a virtual image as the 0th order light L0, and part of the light enters the left eye E1 or the right eye E1 as the 1st order light L1. In the present embodiment, the pillars 13 of the meta-lenses 40 are provided so that the 1st order light L1 is diffracted toward the ocular fundus, as described later.

The controller 403 includes laser light sources of two colors, specifically, a first light source 411 that outputs blue laser light of 445 nm and a second light source 412 that outputs deep red laser light of 675 nm.

The laser light of the two colors is combined by a multiplexer 413 and travels into the left and right eyes of the user through the body 401.

The laser light returns to half mirrors 414 in a reverse order as return light, and enters photodetectors 415 and is detected as image data of the ocular fundus.

The photodetectors 415 are provided as sensors close to the half mirrors, and the laser light of the two colors of the return light separated by the half mirrors is received and detected by two different detectors, respectively.

As described above, in the present example, the image projection device 410 functions as a medical image projection device or a medical eyewear for examining the ocular fundus by using the blue laser light and the deep red laser light.

Data obtained from the detected laser light of the two colors is sent to the mobile terminal 420 by a near field wireless transmitter 419 and is then transmitted to the remote diagnosis terminal 440 via the mobile terminal 420. Both of the near field wireless transmitter 419 and the mobile terminal 420 thus function as a transmitter that transmits image data of the ocular fundus to the remote diagnosis terminal 440.

The remote diagnosis terminal 440 is an information control device such as a server that includes a receiver 441, a transmitter 442, an ocular fundus image generator 443, an image analyzer 444 for analyzing an ocular fundus image generated by the ocular fundus image generator 443 and performing diagnosis, and a database 445 in which various kinds of clinical data are recorded.

In the remote diagnosis terminal 440, the ocular fundus image generator 443 generates an ocular fundus image by using a detection result of the photodetectors 415 obtained via the mobile terminal 420, and the ocular fundus image analyzer 444 analyzes the ocular fundus image and transmits the presence or absence of an abnormality to the mobile terminal 420 by using the transmitter 442. The image projection device 410, the mobile terminal 420, and the remote diagnosis terminal 440 function as the preventive medical care system 400 by these functions.

Such ocular fundus photography is often used for tests of eye diseases such as retinal detachment, glaucoma, and macular degeneration.

In addition, since blood vessels in the ocular fundus are only blood vessels that can be directly observed from an outside in a human body, vascular lesions caused by hypertension, hyperlipidemia, and diabetes, a degree of arteriosclerosis, and the like can be evaluated by seeing blood vessel running of an artery and a vein appearing from an optic disk. From such reasons, the ocular fundus photography is expected to be effective as a test for symptoms of lifestyle-related diseases.

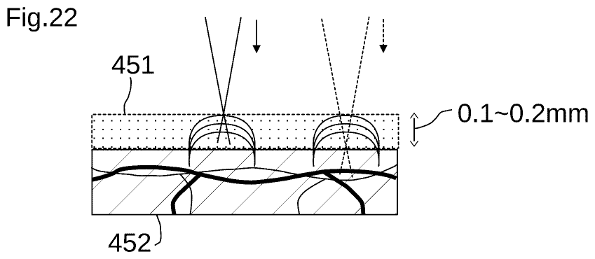

In such ocular fundus examination, both of information of a retinal surface region 451, which is an imaging target on the ocular fundus, and information on a blood vessel running region 452 located slightly deeper than a retina are often needed, as illustrated in FIG. 22.

The retinal surface region 451 and the blood vessel running region 452 are shifted from each other in an optical axis direction by approximately 0.1 mm to 0.2 mm, but to acquire a high-precision image, it is necessary to narrow a beam spot down to a small diameter at a focal position, and therefore such a shift is beyond a depth of focus of an optical system. Therefore, according to a conventional examination device, these two regions are photographed separately by adjusting a focal position of an optical system.

Furthermore, it is known that it is effective to photograph the blood vessel running region 452 and the retinal surface region 451 by using different wavelengths, specifically, red light indicated by the broken line and blue light indicated by the solid line, respectively, as illustrated in FIG. 22 since red light, which has a long wavelength, easily reaches a deep portion of a human body and blue light, which has a short wavelength, is reflected by a human body surface.

It is widely known that chromatic aberration occurs due to differences in refractive index among wavelengths in a typical optical system.

In the example of the present application, regarding such chromatic aberration, a central wavelength is selected so that blue light, which has a short wavelength, is focused on a front side and red light, which has a long wavelength, is focused on a rear side.

By concurrently performing photography with respect to different wavelengths by utilizing such chromatic aberration, the image projection device 410 according to the present embodiment can concurrently photograph the retinal surface region 451 and the blood vessel running region 452, which is located deeper than the retinal surface region 451, by using laser light directed into the eyes of the user.

A mechanism of such a meta-lens 40 is described in more detail.

In the image projection device 410, the 1st order light L1 diffracted by the meta-lens 40 is reflected toward the eye of the user, but the 0th order light L0 that is not diffracted passes through the meta-lens 40 and is separated from the 1st order light L1 to travel along a different path.

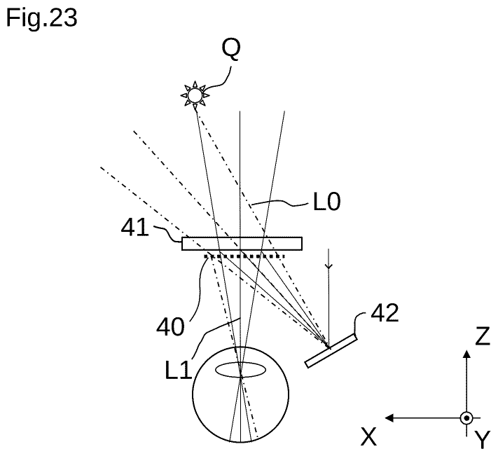

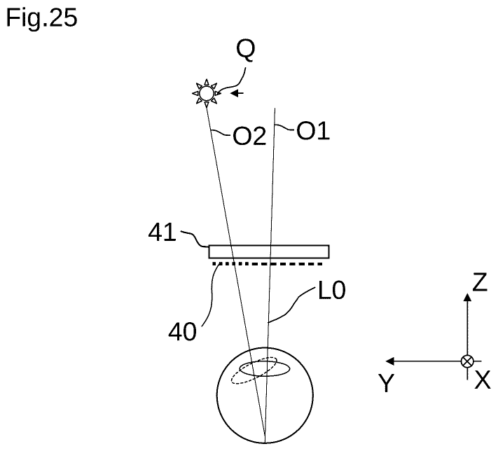

In the image projection device 410, an object Q is displayed as a virtual image by using the 0th order light L0 having any of the wavelengths that has passed through the meta-lens 40 without being diffracted, as illustrated in FIGS. 23 and 25. That is, the user can see, as a virtual image, the object Q projected by the image projection device 410 over view in front of the eye through the eyepiece 41. By displaying the object Q, a user's usual line of sight O1 can be guided toward the object Q as indicated by a line of sight O2, as described later.

In this case, the image projection device 410 is optically designed so that a projection image of the object Q enters the eyes. That is, the image projection device 410 is optically designed so that the projection image enters a pupil position of the user.

In addition, the blue light from the first light source 411 is bent as the 1st order light L1 so as to be focused in the retinal surface region 451 by being refracted by the meta-lens 40, and the red light from the second light source 412 is bent so as to be focused in the blood vessel running region 452.

In the meta-lens 40, a ratio of a light amount of the 0th order light L0 to a light amount of the 1st order light L1 is set to 3:7, and diffraction efficiency is kept low on purpose so that a rate of the 0th order light L0 is higher than that in the meta-lens illustrated in the first embodiment.

In the meta-lens 40 according to the present embodiment, the filling rate of the pillars 13 is controlled so that the blue light from the first light source 411 is refracted as the 1st order light L1 by the meta-lens 40 so as to be focused in the retinal surface region 451, and chromatic aberration is generated so that the red light from the second light source 412 is focused on a side deeper than the retinal surface.

Note that meta-atoms may be arranged in separate regions or may be laminated to optimize a light focus position for each wavelength without using the chromatic aberration.

According to such a configuration, the user sees the virtual image of the object Q in front of the eye as the 0th order light, and part of the light is focused as the 1st order light L1 in the retinal surface region 451, the blood vessel running region 452, or the like in the eye. Note that the ratio of the 0th order light L0 to the 1st order light L1 may also be set to any ratio so that the 0th order light is dominant and the light amount of the 0th order light L0 is larger than that in a case of 1:1.

In particular, in a case of an image projection device for medical use for examining the ocular fundus such as the one according to the present embodiment, a larger laser light amount means a larger exposure amount and is therefore undesirable, and therefore the diffraction efficiency may be adjusted so that the ratio of the light amount of the 0th order light L0 to the light amount of the 1st order light L1 is approximately 9:1.

During ocular fundus examination, a pupil position changes depending on a direction which the user is looking, and it is therefore necessary to correctly determine the user's pupil position and direct light to a correct position of the retinal surface region 451 or the blood vessel running region 452. Although methods such as eye-tracking of determining a pupil position from positions of a black part and a white part of the eye or the like by using a camera are known as means for determining a pupil position, preparing another optical system invites an increase in weight of the body 401 and an increase in cost and therefore is not desirable.

In view of this, in the present embodiment, the line of sight of the user is guided to the object Q by using the 0th order light L0 in addition to the 1st order light L1 used as photographing light, as described above. For example, a configuration for guiding a pupil position to an appropriate position by changing a virtual image position of the object Q in a Y direction is employed, as illustrated in FIG. 25.

That is, the image projection device 410 is provided so that a pupil position guided by the virtual image that is made visible by the 0th order light L0 and a pupil position irradiated with the 1st order light L1 match in a case where the 0th order light L0 that passes through the meta-lens 40 without being diffracted is a transmitted component and the 1st order light L1 that obtains a desired diffraction effect when passing through the meta-lens 40 is a reflected component.

According to the above configuration, both of the blue light from the first light source 411 and the red light from the second light source are directed as the 1st order light L1 to the retinal surface region 451 and the blood vessel running region 452 of the user's ocular fundus to photograph the ocular fundus, and the 0th order light L0 passes through the meta-lens 40 without being diffracted and produces an effect of guiding the user's pupil position as a virtual image of the object Q.

According to this configuration, a plurality of functions, specifically, determination of a pupil position and photography of the retinal surface region 451 and the blood vessel running region 452 in the eye can be provided by using a single optical system without using another optical system.

In the meta-lens 40, the filling rate for obtaining a desired refractive index is decided by the diameters R of the pillars 13, which are fine structures, and the pitch p, as already described with reference to FIG. 2 and other drawings.

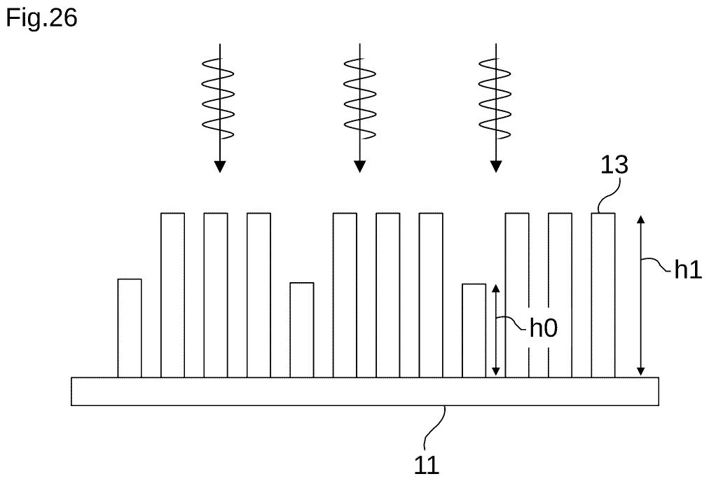

On the other hand, as illustrated in FIG. 26, it is possible to control a light amount of light that passes through the meta-lens 40 as the 0th order light L0 and a light amount of light that passes through the meta-lens 40 as the 1st order light L1 without changing the filling rate by controlling the number of pillars 13 whose height h is h0 and the number of pillars 13 whose height h is h1 or a ratio of the pillars 13 whose height h is h0 and the pillars 13 whose height h is h1 and thus changing a ratio to the wavelength λ of the incident light beam.

This is because in a case where the height h of the pillars 13 does not have a length equivalent to 1 wavelength necessary for the pillars 13 to function as meta-atoms, part of the light passes through the meta-lens 40 as the 0th order light L0 that is not influenced by a refractive index, and a part of the light passes through the meta-lens 40 as the 1st order light L1 that has been influenced by the refractive index. In the meta-lens 40, by thus freely setting the number of pillars 13 whose height is h0 (h0<λ) and the number of pillars 13 whose height is h1 (h1≈λ), diffraction efficiency of the 1st order light L0 can be controlled, and a ratio of the 0th order light L0 and the 1st order light L1 can be controlled.

Note that in terms of difficulty of functioning as meta-atoms, a larger difference between the height h0 of the pillars 13 and the target wavelength λ of the incident light beam is better. Although an example in which the height h0 of the pillars 13 is a lower one has been illustrated in the present embodiment, the height h0 of the pillars 13 may be a higher one.

As described above, in the present embodiment, the ratio of the light amount of the 0th order light L0 to the light amount of the 1st order light L1 can be controlled by controlling the heights h of the pillars 13 of the meta-lens 40.

According to this configuration, use of the meta-lens 40 makes it possible to project a virtual image of the object Q in front of the eyes as the 0th order light L0 and project the 1st order light L1 into the eyes so that the 0th order light L0 and a pupil position match. According to this configuration, the ocular fundus can be photographed while guiding a user's line of sight without the need for another optical system for eye tracking, which is conventionally needed.

Next, a case where a meta-lens 45 in which chromatic aberration is applied as a spectral function is used for a photodetector 415, which is a detector, is described.

The meta-lens 45 that disperses light by using chromatic aberration is placed at an opening 416 of the photodetector 415. The meta-lens 45 has a spectral function of dividing light into wavelengths in accordance with the chromatic aberration of the meta-lens 45 by causing return light used for the ocular fundus photography to enter the meta-lens 45.

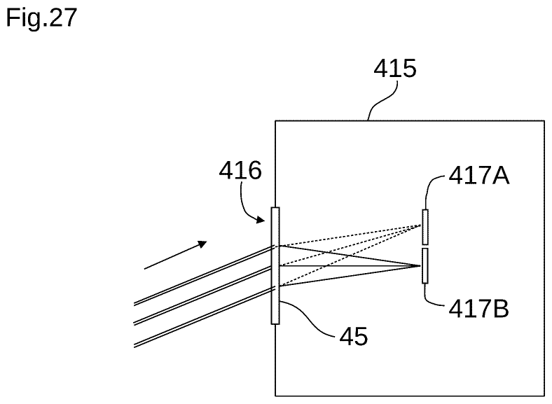

In FIG. 27, red light indicated by the broken lines and blue light indicated by the solid lines that are included in the return light enter different split photodiodes (PDs) 417A and 417B, respectively.

In the present embodiment, the meta-lens 45 is provided so that deep red light and blue light are focused at different positions due to chromatic aberration when the return light is obliquely incident.

Specifically, the split PD 417A is placed close to a focal position where the deep red light is focused, and the split PD 417B is placed close to a focal position where the blue light is focused on the basis of an incident angle of the return light.

According to the photodetector 415 including the meta-lens 45, an image of the blood vessel running region 452 taken by using the deep red light and an image of the retinal surface region 451 taken by using the blue light can be detected by the different split PDs 417A and 417B. According to this configuration, a plurality of images taken by using the meta-lens 40 can be separated by the meta-lens 45, and the images taken by using the respective colors can be detected at once by the photodetector 415 having a spectral function. This produces an effect that photography can be performed in a short time where a user's line of sight is being guided.

In this case, the split PDs 417A and 417B function as independent photodetection units.

That is, the 1st order light L1 is incident as photographing light together with the 0th order light L0 due to the meta-lens 40, and light obtained as return light is detected by the photodetector 415 having a spectral function, and thereby ocular fundus photographs of the blood vessel running region 452 and the retinal surface region 451 can be taken concurrently.

Configurations and manufacturing methods of the meta-lenses 40 and 45 used in the preventive medical care system 400 may be identical to the manufacturing method of the meta-lens 10 described in the first embodiment, and detailed description thereof is omitted.

Note that the meta-lens 40 can be used for a purpose other than the image projection device 410 for medical use.

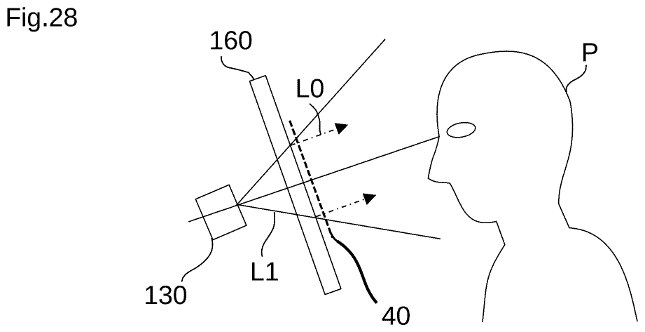

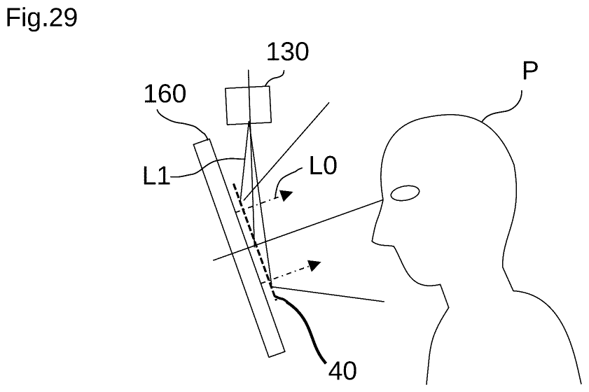

For example, in a case where the meta-lens 40 is embedded in a display monitor 160 such as a PC by using the characteristics of allowing the 0th order light L0, which is a major part of light emitted from a light source, to pass therethrough and focusing only the 1st order light L1, which is part of the light, it is possible to provide a display-transmission-type imaging device 130 by locating the imaging device 130 close to the focal position of the 1st order light L1, as illustrated in FIGS. 28 and 29.

According to this configuration, a user P can be photographed by the imaging device 130 while the user P is visually observing light emission of the display monitor 160 as the 0th order light L0. Conventionally, during teleconference or the like, the user P is looking at a display monitor, and therefore the user P is looking away in an image which a communication partner sees. However, the display-transmission-type imaging device 130 makes it possible to acquire an image in which a line of sight of the user meets that of a communication partner even in a case where the user is looking at the display monitor 160. This produces an effect that the user can talk with the communication partner while looking at an image where the lines of sight meet.

As a modification of this configuration, the imaging device 130 may be provided around the display monitor 160 so as to be located above the display monitor 160, for example, as illustrated in FIG. 29.

Since the meta-lens 40 allows a large part of light radiated from the display monitor 160 to pass therethrough, the user P can visually observe the display monitor 160.

On the other hand, a large part of peripheral light from the user side passes through the meta-lens 40, but a part of the light, specifically, the 1st order light L1 travels toward the imaging device 130 as reflected diffraction light. According to this configuration, an image in which a line of sight of the user meets that of a communication partner even in a case where the user is looking at the display monitor 160 can be acquired by the imaging device 130, as in FIG. 28. This produces an effect that the user can talk with the communication partner while looking at an image where the lines of sight meet.

As described above, not only a transmission-type meta-lens that allows both of the 0th order light and the 1st order light to pass therethrough, but also a reflection/diffraction type meta-lens that allows the 0th order light to pass therethrough and reflects the 1st order light may be used as the meta-lens 40.

Although the embodiments of the present invention have been described above, the present invention is not limited to the above embodiments, and changes and the like can be made as appropriate within the scope described in the claims.

For example, although the examples in which the meta-lenses 10, 40, and 45 according to the present invention are manufactured by nanoimprint have been described, if similar effects are obtained by controlling the filling rate of the transmission surface 12 in a meta-lens manufactured by a different general method, such a method may be used.

An aspect of the present invention is as follows.
[1] The meta-lens 10 according to the present invention includes a light path separator that causes the 1st order light L1 and the 0th order light L0 of light that has passed through the transmission surface 12 to travel along different light paths, the 1st order light L1 being light that has been influenced by refraction caused by the pillars 13, and the 0th order light L0 being light that has not been influenced by refraction caused by the pillars 13.

According to this configuration, in a case where an optical system using a meta-lens is constructed, influence of 0th order light can be reduced by guiding 1st order light for obtaining a signal to a position outside a light path of the 0th order light.
[2] The meta-lens 10 according to the present invention is the transmission-type meta-lens described in [1], and the transmission surface 12 functioning as the light path separator causes the 1st order light L1 to be focused outside the irradiation range F0 of the 0th order light L0 on the imaging surface position of the meta-lens 10.

According to this configuration, in a case where an optical system using a meta-lens is constructed, influence of 0th order light can be reduced by guiding 1st order light for obtaining a signal to a position outside a light path of the 0th order light.
[3] In addition to the configuration described in [1] or [2], the transmission surface 12 functioning as the light path separator of the meta-lens 10 is provided so that the inclination angle α of the 1st order light L1 with respect to the optical axis center of the transmission surface 12 satisfies the following conditional expression (1):

$$tan α > D / 2 Q \qquad ( 1 )$$

where D is an effective incident diameter of the meta-lens 10 and Q is an optical length to the imaging surface.

According to this configuration, in a case where an optical system using a meta-lens is constructed, influence of 0th order light can be reduced by guiding 1st order light for obtaining a signal to a position outside a light path of the 0th order light.
[4] In addition to the configuration described in any of [1] to [3], the meta-lens 10 has the inclined surface 14 that is opposed to the transmission surface 12 and is inclined with respect to the transmission surface 12.

According to this configuration, in a case where an optical system using a meta-lens is constructed, the 1st order light and the 0th order light separated by the transmission surface 12 can be separated by the inclined surface 13 to travel in different directions, and therefore influence of the 0th order light can be further reduced.
[5] In addition to the configuration described in any of [1] to [4], the meta-lens 10 according to the present invention has the diffusion surface 15 that diffuses the 0th order light L0.

According to this configuration, in a case where an optical system using a meta-lens is constructed, the 1st order light and the 0th order light can be separated by the transmission surface 12, and the 0th order light can be weakened by the diffusion surface 15, and therefore influence of the 0th order light can be further reduced.
[6] In addition to the configuration described in any of [1] to [5], the transmission surface 12 of the meta-lens 10 according to the present invention has a diffusing function in addition to the pillars 13.

According to this configuration, an effect of diffusing light that has passed through a meta-surface is given by the filling rate of the pillars 13.
[7] In addition to the configuration described in any of [1] to [6], the output detection sensor 310 that receives the 0th order light L0 of the meta-lens 10 and detects output of the 0th order light L0 is provided on the light path of the 0th order light L0 on a downstream side relative to the transmission surface 12.

According to this configuration, in a case where an optical system using a meta-lens is constructed, influence of 0th order light can be reduced by guiding 1st order light for obtaining a signal to a position outside a light path of the 0th order light.
[8] In addition to the configuration described in [1], the meta-lens 40 is configured such that the height h0 of some of the pillars 13 having the height h is shifted from a wavelength of the light that passes through the meta-lens 40 to change diffraction efficiency of the 1st order light L1 and adjust a ratio of the 0th order light L0 to the 1st order light L1.

According to this configuration, in a case where an optical system using the meta-lens 40 is constructed, the 0th order light is used for a different purpose in addition to the 1st order light for obtaining a signal, and therefore both of the 1st order light and the 0th order light can be used. This is advantageous in that a plurality of images can be taken concurrently especially in application to a medical image projection device.
[9] In addition to the configuration described in [8], the meta-lens 40 is configured such that a pupil position of the 1st order light L1 matches a pupil position onto which a virtual image of the 0th order light L0 is projected.

According to this configuration, in a case where an optical system using the meta-lens 40 is constructed, the 0th order light is used for a different purpose in addition to the 1st order light for obtaining a signal, and therefore both of the 1st order light and the 0th order light can be used. This is advantageous in that a plurality of images can be taken concurrently especially in application to a medical image projection device.

The image projection device 110 according to the present invention includes the meta-lens 10 described in any one of [1] to [6] or the optical system described in [7], and the light source 111 that emits the light, and at least part of the light that has passed through the meta-lens 10 is projected onto a projection surface.

According to this configuration, in a case where an optical system using a meta-lens is constructed, influence of 0th order light can be reduced by guiding 1st order light for obtaining a signal to a position outside a light path of the 0th order light.
[11] The medical image projection device according to the present invention includes the meta-lens 40 described in [8] or [9], and the first light source 411 and the second light source 412 that emit the light of different types having at least two wavelengths, and the medical image projection device is a wearable medical image projection device that allows a user to visually observe an image projected in front of eyes by the meta-lens 40. The 0th order light L0 included in the light that has passed through the meta-lens 40 guides a pupil position of the user to any position by making the user see an image, and the 1st order light L1 is projected onto an ocular fundus of the user in accordance with the pupil position guided by the 0th order light L0, and the ocular fundus is photographed by the 1st order light L1 used as photographing light concurrently as projection of the image using the 0th order light L0.
[12] In addition to the configuration described in [11], the medical image projection device according to the present invention is configured such that the meta-lens 40 is provided so that a focal position of the light emitted from the first light source 411 and a focal position of the light emitted from the second light source 412 are different in an optical axis direction of the meta-lens 40, different positions of the ocular fundus of the user are photographed by the light emitted from the first light source 411 and the light emitted from the second light source 412, and the light emitted from the first light source 411 and the light emitted from the second light source 412 are input to different light detection units.
[13] The present invention provides a light source device including the meta-lens described in any of [1] to [9] or the light source optical system including the optical system described in [10], and a light source that emits the light.

According to this configuration, in a case where an optical system using a meta-lens is constructed, influence of 0th order light can be reduced by guiding 1st order light for obtaining a signal to a position outside a light path of the 0th order light.
[14] The present invention provides an imaging device including the meta-lens described in any of [1] to [9] or the optical system described in.

According to this configuration, in a case where an optical system using a meta-lens is constructed, influence of 0th order light can be reduced by guiding 1st order light for obtaining a signal to a position outside a light path of the 0th order light.
[15] The present invention provides the optical scanning device 100 including the meta-lens described in any of [1] to [9] or the optical system described in [10].

According to this configuration, in a case where an optical system using a meta-lens is constructed, influence of 0th order light can be reduced by guiding 1st order light for obtaining a signal to a position outside a light path of the 0th order light.

Although preferred embodiments of the present invention have been described above, the present invention is not limited to such specific embodiments, and can be modified or changed in various ways within the scope of the present invention described in the claims, unless otherwise limited in the above description.

The effects described in the embodiments of the present invention are merely examples of most preferable effects produced by the present invention, and the effects produced by the present invention are not limited to the ones described in the embodiments of the present invention.

1. A meta-lens that has a light transmission surface on which a plurality of fine structures are consecutively provided and adjusts a refractive index for light on a basis of a density of the fine structures, the meta-lens comprising a light path separator that causes 1st order light and 0th order light of light that has passed through the transmission surface to travel along different light paths, the 1st order light being light that has been influenced by refraction caused by the fine structures, and the 0th order light being light that has not been influenced by refraction caused by the fine structures.

2. The meta-lens according to claim 1, wherein the light path separator causes the 1st order light to be focused outside an irradiation range of the 0th order light on an imaging surface position of the meta-lens.

3. The meta-lens according to claim 2, wherein
the light path separator is provided so that an inclination angle α of the 1st order light with respect to an optical axis center of the transmission surface satisfies a following conditional expression (1):
$$tan α > D / 2 Q \qquad ( 1 )$$
where D is an effective incident diameter of the meta-lens and Q is an optical length to the imaging surface.

4. The meta-lens according to claim 1, wherein the light path separator has an inclined surface that is opposed to the transmission surface and is inclined with respect to the transmission surface.

5. The meta-lens according to claim 1, wherein the meta-lens has a diffusion surface that diffuses the 0th order light.

6. The meta-lens according to claim 1, wherein the transmission surface has a diffusing function in addition to the fine structures.

7. An optical system comprising the meta-lens according to claim 1, wherein
a detector that receives the 0th order light and detects output of the 0th order light is provided on the light path of the 0th order light on a downstream side relative to the light path separator.

8. The meta-lens according to claim 1, wherein a height of some of the fine structures is shifted from a wavelength of the light that passes through the meta-lens to change diffraction efficiency of the 1st order light and adjust a ratio of the 0th order light to the 1st order light.

9. The meta-lens according to claim 8, wherein a pupil position of the 1st order light matches a pupil position onto which a virtual image of the 0th order light is projected.

10. An image projection device comprising:
the meta-lens according to claim 1; and
a light source that emits the light, wherein
at least part of the light that has passed through the meta-lens is projected onto a projection surface.

11. A medical image projection device comprising:
the meta-lens according to claim 9; and
a first light source and a second light source that emit the light of different types having at least two wavelengths, wherein
the medical image projection device is a wearable medical image projection device that allows a user to visually observe an image projected in front of eyes by the meta-lens,
the 0th order light included in the light that has passed through the meta-lens guides a pupil position of the user to any position by making the user see an image, and the 1st order light is projected onto an ocular fundus of the user in accordance with the pupil position guided by the 0th order light, and
the ocular fundus is photographed by the 1st order light used as photographing light concurrently as projection of the image using the 0th order light.

12. The medical image projection device according to claim 11, wherein
the meta-lens is provided so that a focal position of the light emitted from the first light source and a focal position of the light emitted from the second light source are different in an optical axis direction of the meta-lens, different positions of the ocular fundus of the user are photographed by the light emitted from the first light source and the light emitted from the second light source, and the light emitted from the first light source and the light emitted from the second light source are input to different light detection units.

13. A light source device comprising:
the meta-lens according to claim 1; and
a light source that emits the light.

14. An imaging device comprising the meta-lens according to claim 1.

15. An optical scanning device comprising the meta-lens according to claim 1.
